(19) United States
(12) Patent Application Publication
(10) Pub. No.: US 2015/0121661 A1
(43) Pub. Date: May 7, 2015

(54) Releasable Adhesive Mounting Element

(71) Applicant: David K. Lundahl, Hampton, VA (US)

(72) Inventor: David K. Lundahl, Hampton, VA (US)

(21) Appl. No.: 14/071,719

(22) Filed: Nov. 5, 2013

(51) Int. Cl. C09J 7/02

(52) U.S. Cl. CPC C09J 7/0225
USPC 24/304

(57) ABSTRACT

A releasable adhesive mounting element that includes a segment of material having a determined shape defined by one or more edges and having a first side and a second side. At least one marginal offset area is defined on the second side of the segment of material, which is offset a determined width from the one or more edges of the segment of material. A first adhesive area is defined on the second side of the segment of material, which has edges that extend to the at least one marginal offset area. A first releasable adhesive is disposed within the first adhesive area. The first releasable adhesive is configured for simultaneously, releasably adhering the segment of material to a portion of a work and a portion of a mounting surface. A second adhesive area may be defined at least partially within at least a portion of the first adhesive area.

### NOTICE OF COPYRIGHTED MATERIAL

The disclosure of this patent document contains material that is subject to copyright protection. The copyright owner has no objection to the reproduction by anyone of the patent document or the patent disclosure, as it appears in the Patent and Trademark Office patent file or records, but otherwise reserves all copyright rights whatsoever. Unless otherwise noted, all trademarks and service marks identified herein are owned by the applicant.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

1. Field of the Invention

The present disclosure relates generally to systems and methods for releasably securing items to a surface. More specifically, the present invention relates to releasable adhesive mounting elements that can be releasably secured to a surface of an item or can be used to releasably secure an item to a surface.

2. Description of Related Art

Ofttimes, people exhibit various keepsake or other items on a refrigerator or other surface in a home as a way of remembering a particular event, displaying photographs or artwork, or congratulating someone for a job well done. For example, parents or grandparents typically enjoy displaying a child's artwork projects or exceptional tests or homework assignments on the front or side of the refrigerator.

Typically, the works are temporarily affixed to the refrigerator by one or more magnets. Unfortunately, if a refrigerator includes a surface that is plastic, stainless steel, or some other nonferrous or non-magnetic material, the works cannot be affixed to the surface by magnets. Additionally, the attraction between the magnets and the surface may be weak, such that the magnets may be ineffective to affix the work to the surface, particularly if the work is constructed of a relatively dense construction or other paper.

Furthermore, someone may be hesitant to affix a magnet to a particular surface, such as, for example, the surface of a relatively expensive refrigerator, for fear that the magnet would scratch or blemish the surface.

Additionally, magnets are ineffective on certain surfaces, such as walls, ceilings, doors, credenzas, and other materials constructed from nonmagnetic components or covered with a nonmagnetic covering.

Any discussion of documents, acts, materials, devices, articles, or the like, which has been included in the present specification is not to be taken as an admission that any or all of these matters form part of the prior art base or were common general knowledge in the field relevant to the present disclosure as it existed before the priority date of each claim of this application.

### BRIEF SUMMARY OF THE INVENTION

Thus, the present invention provides systems and methods for releasably securing works or other items to a surface. More specifically, the present invention is directed to various embodiments of releasable adhesive mounting elements that can be releasably secured to a surface of an item or can be used to releasably secure a work or other item to a surface.

In various exemplary, non-limiting embodiments, the releasable adhesive mounting elements of the present invention can be releasably attached to portions of a work or other item using a releasable adhesive on a bottom side thereof. Each mounting element can then be used to removably affix the work or other item to a surface.

Because the releasable adhesive or adhesives are selectively disposed on the bottom side of the releasable adhesive mounting elements, each mounting element can be easily removed from a work without tearing or otherwise marring the work or the surface to which the work was attached.

In various exemplary, non-limiting embodiments, the releasable adhesive mounting element, comprises a segment of paper, plastic, or other material having a determined shape defined by one or more edges and wherein the segment of material has a first side and a second side; at least one marginal offset area defined on the second side of the segment of material, wherein the at least one marginal offset area is offset a determined width from the one or more edges of the segment of material; a first adhesive area defined on the second side of the segment of material, wherein edges of the first adhesive area extend to the at least one marginal offset area; and a first releasable adhesive disposed within the first adhesive area, wherein the first releasable adhesive is configured for simultaneously, releasably adhering the segment of material to a portion of a work and a portion of a mounting surface.

In various exemplary, non-limiting embodiments, the releasable adhesive mounting element comprises a releasable adhesive mounting element, comprising a segment of material having a determined shape defined by one or more edges and wherein the segment of material has a first side and a second side; at least one marginal offset area defined on the second side of the segment of material, wherein the at least one marginal offset area is offset a determined width from the one or more edges of the segment of material; a first adhesive area defined on the second side of the segment of material, wherein edges of the first adhesive area extend to at least one first portion of the marginal offset area; a first releasable adhesive disposed within the first adhesive area; a second adhesive area defined on the second side of the segment of material, wherein edges of the second adhesive area are at least partially defined within at least a portion of the first adhesive area; and a second releasable adhesive disposed within the second adhesive area, wherein the first releasable adhesive is configured for releasably adhering the segment of material to at least a portion of a work, and wherein the second releasable adhesive is configured for releasably adhering the segment of material to at least a portion of a mounting surface.

The at least one adhesive property of the first releasable adhesive is different from at least one adhesive property of the second releasable adhesive.

In various exemplary embodiments, the second adhesive area extends to at least a second portion of the marginal offset area.

In various exemplary, non-limiting embodiments, the releasable adhesive mounting element comprises a releasable adhesive mounting element, comprising a segment of material having a determined shape defined by one or more edges and wherein the segment of material has a first side and a second side; at least one marginal offset area defined on the second side of the segment of material, wherein the at least one marginal offset area is offset a determined width from the one or more edges of the segment of material; a first adhesive area defined on the second side of the segment of material, wherein edges of the first adhesive area are defined within at least one first portion of the marginal offset area; a first releasable adhesive disposed within the first adhesive area; a second adhesive area defined on the second side of the segment of material, wherein edges of the second adhesive area are entirely defined within at least a portion of the first adhesive area; and a second releasable adhesive disposed within the second adhesive area, wherein the first releasable adhesive is configured for releasably adhering the segment of material to at least a portion of a work, and wherein the second releasable adhesive is configured for releasably adhering the segment of material to at least a portion of a mounting surface.

Accordingly, the presently disclosed invention provides a releasable adhesive mounting element that allows a user to releasably attach a work to a surface.

The presently disclosed invention separately provides a releasable adhesive mounting element that can be easily removed from a work without tearing or otherwise marring the work or the surface to which the work was attached.

The presently disclosed invention separately provides a releasable adhesive mounting element that can be used in place of magnets.

The presently disclosed invention separately provides a releasable adhesive mounting element that can be provided in a variety of shapes, sizes, colors, etc. and may include words or phrases, so that the holders can also be used as removable “stickers”.

The presently disclosed invention separately provides a releasable adhesive mounting element that can be removed from the work or a surface without leaving a residue.

The presently disclosed invention separately provides a releasable adhesive mounting element that can be easily applied and removed by a user.

These and other aspects, features, and advantages of the present invention are described in or are apparent from the following detailed description of the exemplary, non-limiting embodiments of the present invention and the accompanying figures. Other aspects and features of embodiments of the present invention will become apparent to those of ordinary skill in the art upon reviewing the following description of specific, exemplary embodiments of the present invention in concert with the figures. While features of the present invention may be discussed relative to certain embodiments and figures, all embodiments of the present invention can include one or more of the features discussed herein. Further, while one or more embodiments may be discussed as having certain advantageous features, one or more of such features may also be used with the various embodiments of the invention discussed herein. In similar fashion, while exemplary embodiments may be discussed below as device, system, or method embodiments, it is to be understood that such exemplary embodiments can be implemented in various devices, systems, and methods of the present invention.

### BRIEF DESCRIPTION OF THE SEVERAL VIEWS OF THE DRAWINGS

As required, detailed exemplary embodiments of the present invention are disclosed herein; however, it is to be understood that the disclosed embodiments are merely exemplary of the invention that may be embodied in various and alternative forms, within the scope of the present invention. The figures are not necessarily to scale; some features may be exaggerated or minimized to illustrate details of particular components. Therefore, specific structural and functional details disclosed herein are not to be interpreted as limiting, but merely as a basis for the claims and as a representative basis for teaching one skilled in the art to employ the present invention.

The exemplary embodiments of this invention will be described in detail, with reference to the following figures, wherein like reference numerals refer to like parts throughout the several views, and wherein:

FIG. 1 illustrates a front view showing a several exemplary embodiments of a releasable adhesive mounting element, according to this invention, wherein the various exemplary embodiments of the releasable adhesive mounting element are affixed to a work or used to affix a work to a mounting surface;

FIG. 2 illustrates an exploded view showing several exemplary embodiments of a releasable adhesive mounting element, according to this invention, wherein the various exemplary embodiments of the releasable adhesive mounting element are affixed to a work or used to affix a work to a mounting surface;

FIG. 3 illustrates a bottom view of a first exemplary embodiment of a releasable adhesive mounting element, according to this invention, wherein the releasable adhesive mounting element has a generally triangular shape;

FIG. 4 illustrates a bottom view of a first exemplary embodiment of a releasable adhesive mounting element, according to this invention, wherein the releasable adhesive mounting element has a generally square shape;

FIG. 5 illustrates a bottom view of a first exemplary embodiment of a releasable adhesive mounting element, according to this invention, wherein the releasable adhesive mounting element has a generally star-like shape;

FIG. 6 illustrates a bottom view of a first exemplary embodiment of a releasable adhesive mounting element, according to this invention, wherein the releasable adhesive mounting element has a generally circular shape;

FIG. 7 illustrates a bottom view of a second exemplary embodiment of a releasable adhesive mounting element, according to this invention, wherein the releasable adhesive mounting element has a generally triangular shape;

FIG. 8 illustrates a bottom view of a second exemplary embodiment of a releasable adhesive mounting element, according to this invention, wherein the releasable adhesive mounting element has a generally square shape;

FIG. 9 illustrates a bottom view of a second exemplary embodiment of a releasable adhesive mounting element, according to this invention, wherein the releasable adhesive mounting element has a generally star-like shape;

FIG. 10 illustrates a bottom view of a second exemplary embodiment of a releasable adhesive mounting element, according to this invention, wherein the releasable adhesive mounting element has a generally circular shape;

FIG. 11 illustrates a top view of an exemplary embodiment of a releasable adhesive mounting element, wherein the releasable adhesive mounting element is affixed to a work, according to this invention;

FIG. 12 illustrates a bottom view of a third exemplary embodiment of a releasable adhesive mounting element, according to this invention, wherein the releasable adhesive mounting element has a generally triangular shape;

FIG. 13 illustrates a bottom view of a third exemplary embodiment of a releasable adhesive mounting element, according to this invention, wherein the releasable adhesive mounting element has a generally square shape;

FIG. 14 illustrates a bottom view of a third exemplary embodiment of a releasable adhesive mounting element, according to this invention, wherein the releasable adhesive mounting element has a generally star-like shape; and

FIG. 15 illustrates a bottom view of a third exemplary embodiment of a releasable adhesive mounting element, according to this invention, wherein the releasable adhesive mounting element has a generally circular shape.

### DETAILED DESCRIPTION OF THE INVENTION

For simplicity and clarification, the design factors and operating principles of the releasable adhesive mounting element according to this invention are explained with reference to various exemplary embodiments of a releasable adhesive mounting element according to this invention. The basic explanation of the design factors and operating principles of the releasable adhesive mounting element is applicable for the understanding, design, and operation of the releasable adhesive mounting element of this invention. It should be appreciated that the releasable adhesive mounting element can be adapted to many applications where items can be affixed to a work or a surface.

It should also be appreciated that the terms “mounting element”, “adhesive”, “releasable adhesive”, and “releasable adhesive mounting element” are used for basic explanation and understanding of the operation of the systems, methods, and apparatuses of this invention. Therefore, the terms “mounting element”, “adhesive”, “releasable adhesive”, and “releasable adhesive mounting element” are not to be construed as limiting the systems, methods, and apparatuses of this invention. Thus, the terms “mounting element” and “releasable adhesive mounting element” are to be understood to broadly include any structures or devices capable of being releasably affixed to a work or a surface.

For simplicity and clarification, the releasable adhesive mounting element of this invention will be described as being used to affix a work to a surface, i.e., a paper work to the surface of a refrigerator. However, it should be appreciated that these are merely exemplary embodiments of the releasable adhesive mounting element and are not to be construed as limiting this invention. Thus, the releasable adhesive mounting element of this invention may be utilized to affix a releasable adhesive mounting element to any surface or any work to any surface for any application.

Throughout this application the word “comprise”, or variations such as “comprises” or “comprising” are used. It will be understood that these terms are meant to imply the inclusion of a stated element, integer, step, or group of elements, integers, or steps, but not the exclusion of any other element, integer, step, or group of elements, integers, or steps.

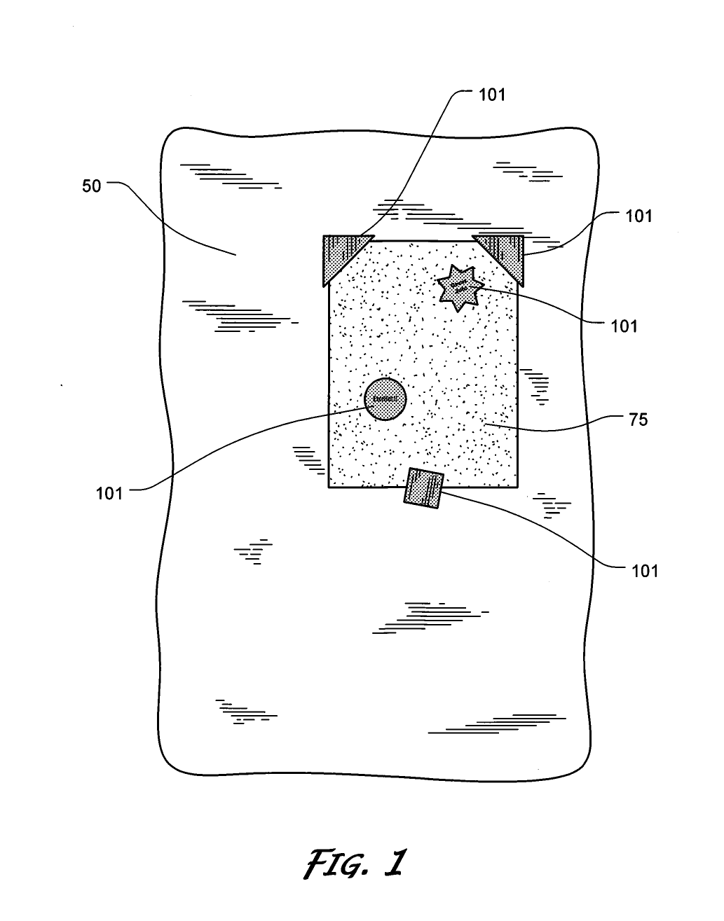

Turning now to the drawing FIGS., FIGS. 1-6 illustrate certain elements and/or aspects of a first exemplary embodiment of the releasable adhesive mounting element 100, according to this invention. In illustrative, non-limiting embodiment(s) of this invention, as illustrated in FIGS. 1-6, the releasable adhesive mounting element 100 comprises at least some of a segment of material 101 having one or more edges 103 and having a first side 105 and a second side 107, at least one marginal offset area 120, and a first adhesive area 110.

In various exemplary embodiments, the segment of material 101 comprises a segment of material 101 having a first side 105 and a second side 107. Typically, the first side 105 is opposite the second side 107. However, if the segment of material 101 does not have a uniform thickness, the first side 105 may not be strictly opposite the second side 107.

In various exemplary embodiments, the segment of material 101 is substantially flexible and is formed of plastic or paper. Alternate materials of construction of the segment of material 101 may include one or more of the following: woven fabrics, canvas, acrylics, sheet fabrics, films, nylon, vinyl, Polyvinyl Chloride (PVC), neoprene, and/or various combinations of the foregoing.

Thus, it should be appreciated that the material or materials listed above are to be given their broadest meanings and that the particular material or materials used to form the segment of material 101 is a design choice based on the desired appearance and/or functionality of the releasable adhesive mounting element 100.

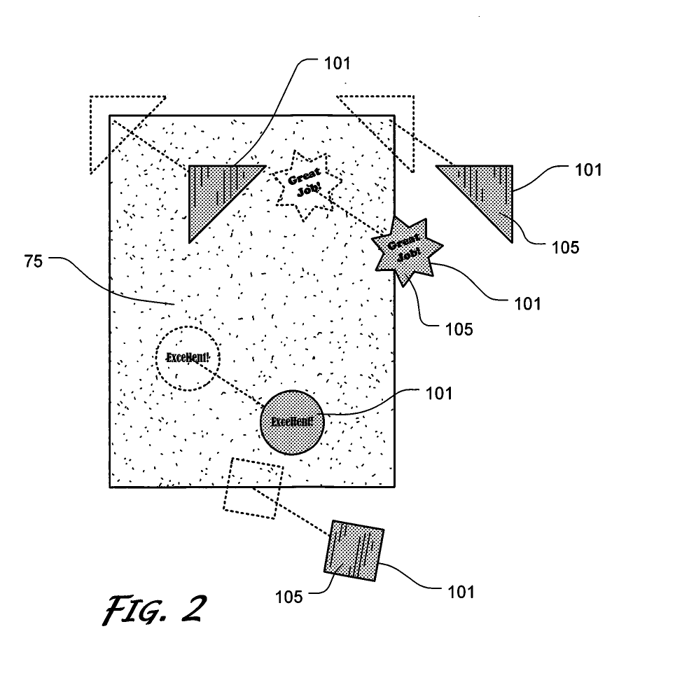

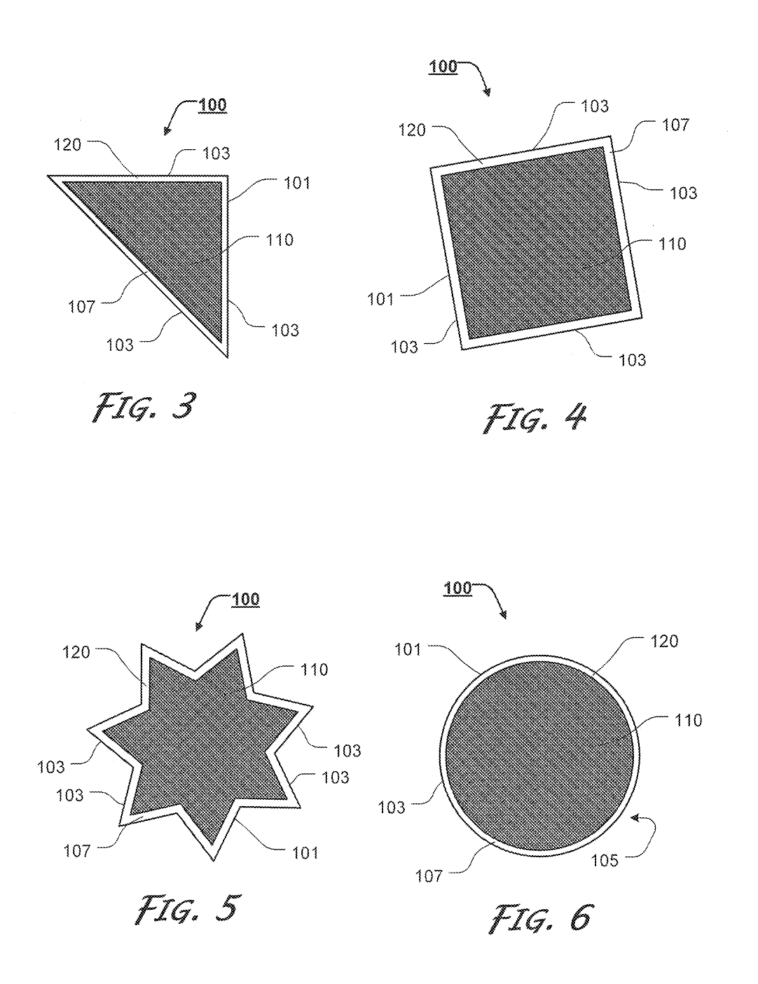

The segment of material 101 has a determined shape defined by one or more edges 103. As illustrated most clearly in FIGS. 3-6, the segment of material 101 may generally be in the shape of a triangle, square, star, or circle. It should be appreciated that the overall size and shape of the segment of material 101 is not limited to triangular, square, star-light, or circular shapes and that the overall size and shape of a given segment of material 101, and the various portions thereof, is a design choice based upon the desired appearance and/or functionality of the releasable adhesive mounting element 100. Furthermore, as illustrated in FIGS. 1 and 2, various exemplary embodiments of the releasable adhesive mounting element 100 may include writing or other annotations or preparations on at least the first side 105 of the segment of material 101.

As further illustrated in FIGS. 3-6, at least one marginal offset area 120 is defined on the second side 107 of each segment of material 101. Each marginal offset area 120 is offset a determined distance or width from the one or more edges 103 of the segment of material 101.

In certain exemplary embodiments, the at least one marginal offset area is offset an equidistance from each of the one or more edges 103 of the segment of material 101. In this manner, the at least one marginal offset area 120 substantially replicates the determined shape of the segment of material 101. Thus, for example, if the segment of material 101 has an overall triangular shape, the at least one marginal offset area 120 will have a complementary, triangular shape. Likewise, if the segment of material 101 has an overall star-like shape, the at least one marginal offset area 120 will have a complementary, star-like shape.

A first adhesive area 110 is defined on the second side 107 of the segment of material 101, within the boundaries or edges of the first adhesive area 110, such that the first adhesive area 110 extends to the at least one marginal offset area 120.

A first releasable adhesive is disposed within the first adhesive area 110. The first releasable adhesive comprises a releasable or releasable pressure sensitive adhesive. The first releasable adhesive is selected to provide simultaneous, releasable adhesion of the segment of material 101 to a portion of a work 75 and a portion of a mounting surface 50, as illustrated in FIGS. 1 and 2.

It should also be appreciated that a more detailed explanation of the specific adhesive or adhesives used for the first releasable adhesive (and the second releasable adhesive) and/or instructions and/or techniques necessary for the implementation and/or application of the releasable adhesive to the second side 107 are not provided herein because such releasable adhesives are commercially available and/or such background information will be known to one of ordinary skill in the art. Therefore, it is believed that the level of description provided herein is sufficient to enable one of ordinary skill in the art to understand and apply the releasable adhesive to the second side 107 of the segment of material 101.

By providing the first releasable adhesive solely within the first adhesive area 110 to and not disposing the first releasable adhesive with in the at least one marginal offset area 120, the at least one marginal offset area 120 provides a border area on the second side 107 of the segment of material 101 that allows a user to establish a more secure grip or purchase on the segment of material 101 for removal of the releasable adhesive mounting element 100 after it has been a fixed or applied to a work 75 and/or a mounting surface 50. The actual distance or width of offset of the at least one marginal offset area 120 from the one or more edges 103 of the segment of material 101 may be varied to provide a larger or smaller adhesive free area, thereby increasing or decreasing the amount of purchase provided proximate the edges 103 of the segment of material 101.

During use of the releasable adhesive mounting elements 100, as most clearly illustrated in FIGS. 1 and 2, the releasable adhesive mounting elements 100 can be placed proximate edges or corners of a work 75 such that a portion of the first releasable adhesive area 110 contacts a portion of the work 75 and also extends beyond at least a portion of the work 75. The portion of the first releasable adhesive area 110 that extends beyond the work 75 can be releasably attached to the desired mounting surface 50.

When it is desired to remove the work 75 from the mounting surface 50, the at least one marginal offset area 120 provides an area of purchase for the user to pull up and remove the releasable adhesive mounting element 100. The releasable adhesive in the first adhesive area 110 allows the releasable adhesive mounting element 100 to be removed from the work 75 and the mounting surface 50 without marring the work 75 or leaving a residue on the work 75 or the mounting surface 50. Thus, the integrity of the work 75 can be maintained.

In alternate uses of the releasable adhesive mounting elements 100, as also illustrated in FIGS. 1 and 2, the releasable adhesive mounting elements 100 can be placed entirely a top the work 75 such that the first releasable adhesive area 110 only contacts the work 75 (or only contacts the mounting surface 50) and acts as a “sticker”. When used as a “sticker”, the releasable adhesive mounting elements can be more easily removed from the work 75 (or the mounting surface 50), because of the at least one marginal offset area 120.

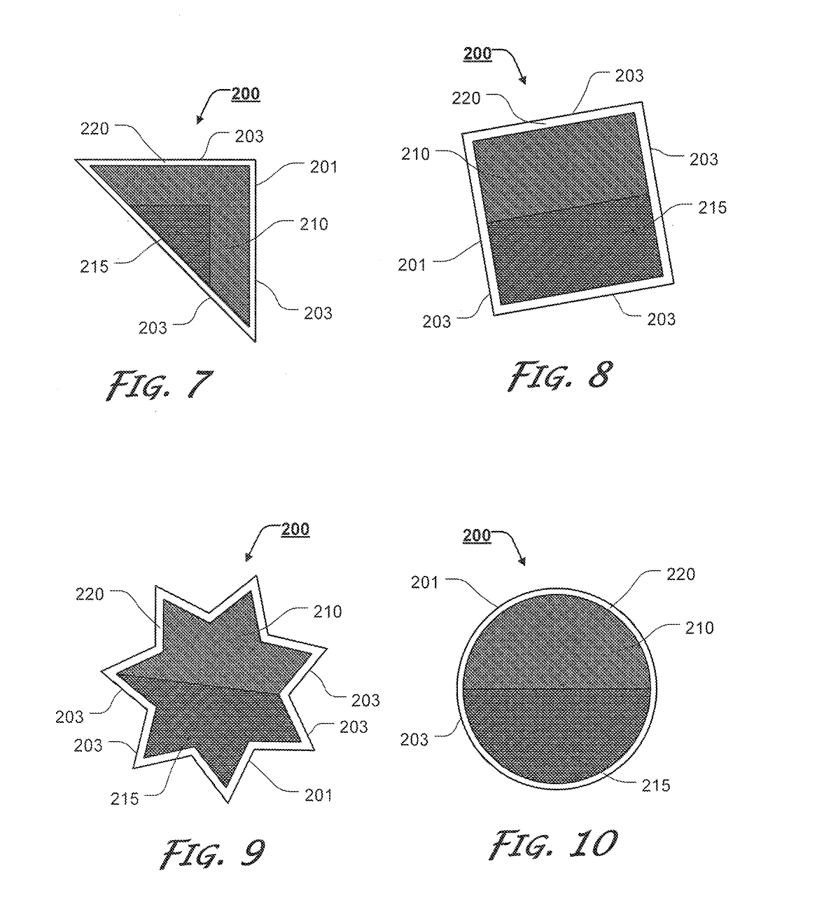

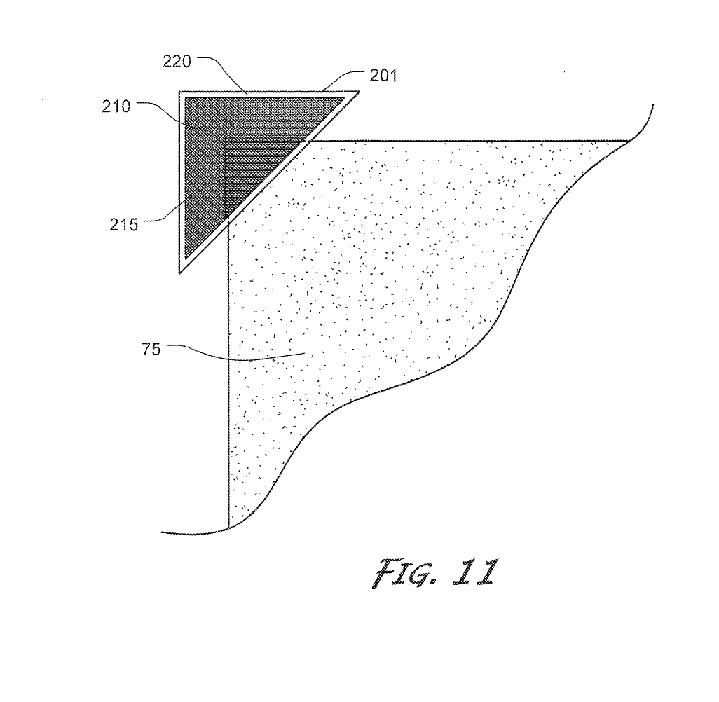

FIGS. 7-11 illustrate certain elements and/or aspects of a second exemplary embodiment of the releasable adhesive mounting element 200, according to this invention. In illustrative, non-limiting embodiment(s) of this invention, as illustrated in FIGS. 7-11, the releasable adhesive mounting element 200 comprises at least some of a segment of material 201 having one or more edges 203 and having a first side 205 and a second side 207, at least one marginal offset area 220, and a first adhesive area 210

It should be understood that each of these elements corresponds to and operates similarly to the releasable adhesive mounting element 100, the segment of material 101, the one or more edges 103, the first side 105, the second side 107, the at least one marginal offset area 120, and the first adhesive area 110, as described above with reference to the releasable adhesive mounting element 100 of FIGS. 1-6.

However, as shown in FIGS. 7-11, a second adhesive area 215 is also defined on the second side 207 of the segment of material 201. The edges of the second adhesive area 215 are at least partially defined within at least a portion of the first adhesive area 210. In certain exemplary embodiments, the edges of the second adhesive area 215 are at least partially defined within at least a portion of the first adhesive area 210 and extend to at least a second portion of the marginal offset area 220. In this manner, the second adhesive area 215 is bounded by a portion of the marginal offset area 220 and a portion of the first adhesive area 210, while the first adhesive area 210 is bounded by a portion of the marginal offset area 220 and a portion of the second adhesive area 215.

A second releasable adhesive is disposed within the second adhesive area 215. At least one adhesive property of the first releasable adhesive, typically the degree of releasable adhesion, is different from at least one adhesive property of the second releasable adhesive. In this manner, the first releasable adhesive is configured for releasably adhering the segment of material 201 to at least a portion of a work 75, while the second releasable adhesive is configured for releasably adhering the segment of material 201 to at least a portion of a mounting surface 50.

In applications where the mounting surface 50 is more durable than the work 75, the first releasable adhesive can have higher adhesion properties than the second releasable adhesive. Thus, the adhesion between the first releasable adhesive and the mounting surface 50 can be greater than the adhesion between the second releasable adhesive and the work 75.

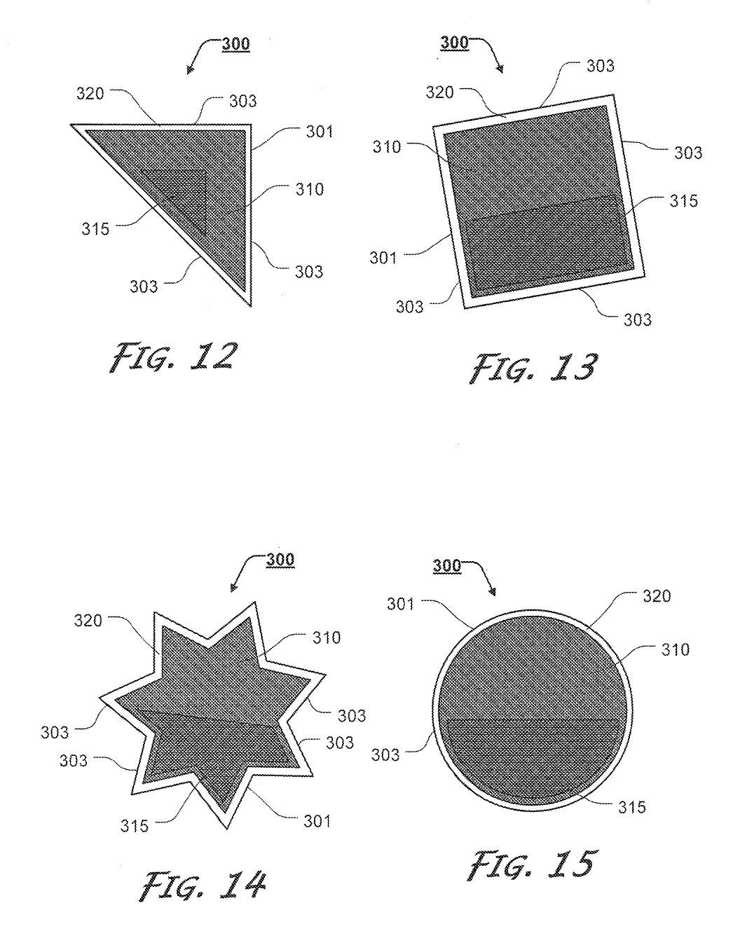

FIGS. 12-15 illustrate certain elements and/or aspects of a third exemplary embodiment of the releasable adhesive mounting element 300, according to this invention. In illustrative, non-limiting embodiment(s) of this invention, as illustrated in FIGS. 12-15, the releasable adhesive mounting element 300 comprises at least some of a segment of material 301 having one or more edges 303 and having a first side 305 and a second side 307, at least one marginal offset area 320, and a first adhesive area 310

It should be understood that each of these elements corresponds to and operates similarly to the releasable adhesive mounting element 100, the segment of material 101, the one or more edges 103, the first side 105, the second side 107, the at least one marginal offset area 120, and the first adhesive area 110, as described above with reference to the releasable adhesive mounting element 100 of FIGS. 1-6.

However, as shown in FIGS. 12-15, a second adhesive area 315 is also defined on the second side 307 of the segment of material 301. The edges of the second adhesive area 315 are completely defined within and bounded by at least a portion of the first adhesive area 310. In this manner, the second adhesive area 315 is completely contained within the first adhesive area 310.

A second releasable adhesive is disposed within the second adhesive area 315. At least one adhesive property of the first releasable adhesive, typically the degree of releasable adhesion, is different from at least one adhesive property of the second releasable adhesive. In this manner, the first releasable adhesive is configured for releasably adhering, for example, the segment of material 301 to at least a portion of a work 75, while the second releasable adhesive is configured for releasably adhering the segment of material 301 to at least a portion of a mounting surface 50.

While this invention has been described in conjunction with the exemplary embodiments outlined above, the foregoing description of exemplary embodiments of the invention, as set forth above, are intended to be illustrative, not limiting and the fundamental invention should not be considered to be necessarily so constrained. It is evident that the invention is not limited to the particular variation set forth and many alternatives, adaptations modifications, and/or variations will be apparent to those skilled in the art.

Furthermore, where a range of values is provided, it is understood that every intervening value, between the upper and lower limit of that range and any other stated or intervening value in that stated range is encompassed within the invention. The upper and lower limits of these smaller ranges may independently be included in the smaller ranges and is also encompassed within the invention, subject to any specifically excluded limit in the stated range. Where the stated range includes one or both of the limits, ranges excluding either or both of those included limits are also included in the invention.

It is to be understood that the phraseology of terminology employed herein is for the purpose of description and not of limitation. Unless defined otherwise, all technical and scientific terms used herein have the same meaning as commonly understood by one of ordinary skill in the art to which this invention belongs.

In addition, it is contemplated that any optional feature of the inventive variations described herein may be set forth and claimed independently, or in combination with any one or more of the features described herein.

Accordingly, the foregoing description of exemplary embodiments will reveal the general nature of the invention, such that others may, by applying current knowledge, change, vary, modify, and/or adapt these exemplary, non-limiting embodiments for various applications without departing from the spirit and scope of the invention and elements or methods similar or equivalent to those described herein can be used in practicing the present invention. Any and all such changes, variations, modifications, and/or adaptations should and are intended to be comprehended within the meaning and range of equivalents of the disclosed exemplary embodiments and may be substituted without departing from the true spirit and scope of the invention.

Also, it is noted that as used herein and in the appended claims, the singular forms “a”, “and”, “said”, and “the” include plural referents unless the context clearly dictates otherwise. Conversely, it is contemplated that the claims may be so-drafted to require singular elements or exclude any optional element indicated to be so here in the text or drawings. This statement is intended to serve as antecedent basis for use of such exclusive terminology as “solely”, “only”, and the like in connection with the recitation of claim elements or the use of a “negative” claim limitation(s).

What is claimed is:

1. A releasable adhesive mounting element, comprising:
a segment of material having a determined shape defined by one or more edges and wherein said segment of material has a first side and a second side;
at least one marginal offset area defined on said second side of said segment of material, wherein said at least one marginal offset area is offset a determined width from said one or more edges of said segment of material;
a first adhesive area defined on said second side of said segment of material, wherein edges of said first adhesive area extend to said at least one marginal offset area; and
a first releasable adhesive disposed within said first adhesive area, wherein said first releasable adhesive is configured for simultaneously, releasably adhering said segment of material to a portion of a work and a portion of a mounting surface.

2. The releasable adhesive mounting element of claim 1, wherein said first side and said second side are opposing sides.

3. The releasable adhesive mounting element of claim 1, wherein said at least one marginal offset area is offset an equidistance from each of said one or more edges of said segment of material.

4. The releasable adhesive mounting element of claim 1, wherein said at least one marginal offset area substantially replicates said determined shape of said segment of material.

5. The releasable adhesive mounting element of claim 1, wherein said first releasable adhesive is not disposed within said at least one marginal offset area.

6. A releasable adhesive mounting element, comprising:
a segment of material having a determined shape defined by one or more edges and wherein said segment of material has a first side and a second side;
at least one marginal offset area defined on said second side of said segment of material, wherein said at least one marginal offset area is offset a determined width from said one or more edges of said segment of material;
a first adhesive area defined on said second side of said segment of material, wherein edges of said first adhesive area extend to at least one first portion of said marginal offset area;
a first releasable adhesive disposed within said first adhesive area;
a second adhesive area defined on said second side of said segment of material, wherein edges of said second adhesive area are at least partially defined within at least a portion of said first adhesive area; and
a second releasable adhesive disposed within said second adhesive area.

7. The releasable adhesive mounting element of claim 6, wherein said first side and said second side are opposing sides.

8. The releasable adhesive mounting element of claim 6, wherein said at least one marginal offset area is offset an equidistance from each of said one or more edges of said segment of material.

9. The releasable adhesive mounting element of claim 6, wherein said at least one marginal offset area substantially replicates said determined shape of said segment of material.

10. The releasable adhesive mounting element of claim 6, wherein said first releasable adhesive is configured for releasably adhering said segment of material to at least a portion of a work, and wherein said second releasable adhesive is configured for releasably adhering said segment of material to at least a portion of a mounting surface.

11. The releasable adhesive mounting element of claim 6, wherein said first releasable adhesive and said second releasable adhesive are not disposed within said at least one marginal offset area.

12. The releasable adhesive mounting element of claim 6, wherein said second adhesive area extends to at least a second portion of said marginal offset area.

13. The releasable adhesive mounting element of claim 6, wherein at least one adhesive property of said first releasable adhesive is different from at least one adhesive property of said second releasable adhesive.

14. A releasable adhesive mounting element, comprising:
a segment of material having a determined shape defined by one or more edges and wherein said segment of material has a first side and a second side;
at least one marginal offset area defined on said second side of said segment of material, wherein said at least one marginal offset area is offset a determined width from said one or more edges of said segment of material;
a first adhesive area defined on said second side of said segment of material, wherein edges of said first adhesive area are defined within at least one first portion of said marginal offset area;
a first releasable adhesive disposed within said first adhesive area;
a second adhesive area defined on said second side of said segment of material, wherein edges of said second adhesive area are entirely defined within at least a portion of said first adhesive area; and
a second releasable adhesive disposed within said second adhesive area.

15. The releasable adhesive mounting element of claim 14, wherein said first side and said second side are opposing sides.

16. The releasable adhesive mounting element of claim 14, wherein said at least one marginal offset area is offset an equidistance from each of said one or more edges of said segment of material.

17. The releasable adhesive mounting element of claim 14, wherein said at least one marginal offset area substantially replicates said determined shape of said segment of material.

18. The releasable adhesive mounting element of claim 14, wherein said first releasable adhesive is configured for releasably adhering said segment of material to at least a portion of a work, and wherein said second releasable adhesive is configured for releasably adhering said segment of material to at least a portion of a mounting surface.

19. The releasable adhesive mounting element of claim 14, wherein said first releasable adhesive and said second releasable adhesive are not disposed within said at least one marginal offset area.

20. The releasable adhesive mounting element of claim 14, wherein at least one adhesive property of said first releasable adhesive is different from at least one adhesive property of said second releasable adhesive.
